(19) United States
(12) Patent Application Publication
(10) Pub. No.: US 2026/0289191 A1
(43) Pub. Date: Sep. 24, 2026

(54) SUBTITLE PROCESSING METHOD AND DEVICE, ELECTRONIC DEVICE AND COMPUTER READABLE STORAGE MEDIUM

(71) Applicant: AMLOGIC (SHANGHAI) CO., LTD., Shanghai (CN)

(72) Inventors: Yayun Ren, Shanghai (CN); Tingting Dong, Shanghai (CN); Jinhong Zhang, Shanghai (CN)

(21) Appl. No.: 19/271,779

(22) Filed: Jul. 17, 2025

(30) Foreign Application Priority Data
Mar. 18, 2025 (CN) 202510322747.7

(51) Int. Cl. G06F 40/58; G10L 15/26

(52) U.S. Cl. CPC G06F 40/58; G10L 15/26

(57) ABSTRACT

The present disclosure discloses a subtitle processing method and device, an electronic device and a computer readable storage medium. The method includes: receiving one or more subtitle translation request instructions sent by one or more terminals; determining one or more target language types based on the one or more subtitle translation request instructions; obtaining an original language type corresponding to an original video to be translated and an original subtitle language in the original video; translating, in response to a language type represented by the original subtitle language being consistent with the original language type, the original subtitle language into the one or more target languages corresponding to the one or more target language types.

### CROSS-REFERENCE TO RELATED APPLICATIONS

The present application claims priority to Chinese Patent Application No. 202510322747.7 filed with China National Intellectual Property Administration on Mar. 18, 2025 and entitled “SUBTITLE PROCESSING METHOD AND DEVICE, ELECTRONIC DEVICE AND COMPUTER READABLE STORAGE MEDIUM”, which is incorporated herein by reference in its entirety.

### TECHNICAL FIELD

The present disclosure relates to the technical field of subtitle translation, and more particularly, to a subtitle processing method, a subtitle processing device, an electronic device and a computer readable storage medium.

### BACKGROUND

In the related art, traditional solutions for video subtitle translation exhibit significant shortcomings in addressing the language requirements of video content and ensuring cross-platform and cross-device compatibility. These solutions are often limited to single language processing, and cannot effectively support multi-device synchronous usage scenarios. Consequently, they cannot provide personalized language output for audiences with different language requirements and audiences who require multiple languages simultaneously. It means that users cannot enjoy personalized viewing experiences across different devices based on their language preferences, especially during multi-user viewing scenarios.

### SUMMARY

The present disclosure aims to resolve at least one of the technical problems in the related art.

Therefore, one aim of the present disclosure is to provide a subtitle processing method. The method targetedly determines one or more target language types through receiving subtitle translation request instructions sent by one or more terminals, and translates the original subtitle language in the original video into the one or more target languages so as to satisfy users' diverse language needs and to provide users with personalized and customized subtitle translation services to enhance their viewing experience.

Therefore, a second aim of the present disclosure is to provide a subtitle processing device.

Therefore, a third aim of the present disclosure is to provide an electronic device.

Therefore, a fourth aim of the present disclosure is to provide a non-transitory computer readable storage medium.

To achieve the above aims, an embodiment in a first aspect of the present disclosure provides a subtitle processing method. The method includes: receiving one or more subtitle translation request instructions sent by one or more terminals, the subtitle translation request instruction at least including a target language type required; determining one or more target language types based on the one or more subtitle translation request instructions; obtaining an original language type corresponding to an original video to be translated and an original subtitle language in the original video; and translating, in response to a language type represented by the original subtitle language being consistent with the original language type, the original subtitle language into one or more target languages corresponding to the one or more target language types.

Through the subtitle processing method according to the embodiment of the present disclosure, one or more target language types are determined targetedly through reception of subtitle translation request instructions sent by one or more terminals, and thus the original subtitle language in the original video is translated into one or more target languages so as to satisfy users' diverse language needs and to provide users with personalized and customized subtitle translation services, thereby enhancing user's viewing experience.

In addition, the subtitle processing method according to the embodiment of the present disclosure further includes following additional technical features.

In some examples, the obtaining the original subtitle language in the original video includes obtaining a subtitle type of the original subtitle in the original video; and obtaining the original subtitle language based on the subtitle type.

In some examples, the obtaining the original subtitle language based on the subtitle type includes: obtaining, in response to the subtitle type indicating an embedded subtitle, text information of the embedded subtitle, and obtaining the original subtitle language based on the text information; obtaining, in response to the subtitle type indicating an image-based subtitle, text information of the image-based subtitle through an optical character recognition technology, and obtaining the original subtitle language based on the text information; and converting, in response to the subtitle type indicating a blank subtitle, audio data of the original video into text information through an automatic speech recognition technology, and obtaining the original subtitle language based on the text information.

In some examples, the converting the audio data of the original video into the text information through the automatic speech recognition technology and obtaining the original subtitle language based on the text information further include: determining start time and end time of an audio based on an length of the audio data; determining a timestamp corresponding to the original subtitle language based on the start time and the end time; and obtaining the original subtitle language based on the text information and the timestamp.

In some examples, the translating the original subtitle language into the one or more target languages corresponding to the one or more target language types includes: translating the original subtitle language based on a Transformer architecture model so as to obtain the one or more target languages.

In some examples, the subtitle processing method further includes: synthesizing, in response to receiving a speech synthesis request instruction, the one or more target languages into one or more target speeches corresponding thereto based on a text-to-speech model; and outputting the one or more target languages and the one or more target speeches to the one or more terminals.

In some examples, the synthesizing the one or more target languages into the one or more target speeches corresponding thereto based on the text-to-speech model further includes: obtaining a speech synthesis parameter set by a user; and performing speech synthesis on the one or more target languages based on the speech synthesis parameter to obtain the one or more target speeches.

To achieve the above aims, an embodiment in a second aspect of the present disclosure provides a subtitle processing device. The subtitle processing device includes: a receiving module configured to receive one or more subtitle translation request instructions sent by one or more terminals, the subtitle translation request instruction at least including a target language type required; a determining module configured to determine one or more target language types based on the one or more subtitle translation request instructions; a subtitle acquisition module configured to obtain an original language type corresponding to an original video to be translated and an original subtitle language in the original video; and a subtitle translation module configured to translate, when a language type represented by the original subtitle language is consistent with the original language type, the original subtitle language into one or more target languages corresponding to the one or more target language types.

With the subtitle processing device in the present disclosure, one or more target language types are determined targetedly through reception of subtitle translation request instructions sent by one or more terminals, and thus the original subtitle language in the original video is translated into one or more target languages so as to satisfy users' diverse language needs and to provide users with personalized and customized subtitle translation services, thereby enhancing user's viewing experience.

To achieve the above aims, an embodiment in a third aspect of the present disclosure provides an electronic device. The electronic device includes the subtitle processing device according to the embodiment in the second aspect of the present disclosure. Alternatively, the electronic device includes a processor, a memory and a subtitle processing program that is stored in the memory and that is executable in the processor. The subtitle processing program when executed by the processor, implements the subtitle processing method according to any of the embodiment in the first aspect of the present disclosure.

With the electronic device according to the embodiment of the present disclosure, one or more target language types can be determined targetedly through reception of subtitle translation request instructions sent by one or more terminals, and thus the original subtitle language in the original video can be translated into one or more target languages so as to satisfy users' diverse language needs and to provide users with personalized and customized subtitle translation services, thereby enhancing user's viewing experience.

To achieve the above aims, an embodiment in a fourth aspect of the present disclosure provides a non-transitory computer readable storage medium. A subtitle processing program is stored on the non-transitory computer readable storage medium. The subtitle processing program when executed by a processor, implements the subtitle processing method according to the embodiment in the first aspect of the present disclosure.

With the non-transitory computer readable storage medium according to the embodiment of the present disclosure, when the subtitle processing program stored on the non-transitory computer readable storage medium is executed by a processor, one or more target language types can be determined targetedly through reception of subtitle translation request instructions sent by one or more terminals, and thus the original subtitle language in the original video can be translated into one or more target languages so as to satisfy users' diverse language needs and to provide users with personalized and customized subtitle translation services, thereby enhancing user's viewing experience.

The additional aspects and advantages of the present disclosure will be partially presented in the following description, partially be clarified from the description below, or be understood through practice of the present disclosure.

### BRIEF DESCRIPTION OF THE DRAWINGS

The above and/or other additional aspects and advantages of the present disclosure become apparent and comprehensible from the description of embodiments in connection with accompanying drawings, in which:

FIG. 1 is a schematic flow diagram of a subtitle processing method according to an embodiment of the present disclosure;

FIG. 2 is a schematic flow diagram of a subtitle processing method according to another embodiment of the present disclosure;

FIG. 3 is a schematic structure diagram showing receiving a subtitle request instruction and transmitting a target language according to an embodiment of the present disclosure;

FIG. 4 is a schematic flow diagram of a speech synthesis processing according to an embodiment of the present disclosure; and

FIG. 5 is a schematic structure diagram of a subtitle processing device according to an embodiment of the present disclosure;

### REFERENCE NUMERALS

subtitle processing device 100; receiving module 110; determining module 120; subtitle acquisition module 130; subtitle translation module 140.

### DETAILED DESCRIPTION

In order to provide a more comprehensive understanding of the features and technical content of the embodiments of the present disclosure, the implementation of the embodiments of the present disclosure will be described in detail below with reference to the accompanying drawings. The accompanying drawings are provided for illustrative purposes only and are not intended to limit the embodiments of the present disclosure. In the following technical description, for the convenience of explanation, multiple details are provided to offer a thorough understanding of the disclosed embodiments. However, in the absence of these details, one or more embodiments may still be implemented. In other cases, to simplify the accompanying drawings, well-known structures and devices may be presented in a simplified manner.

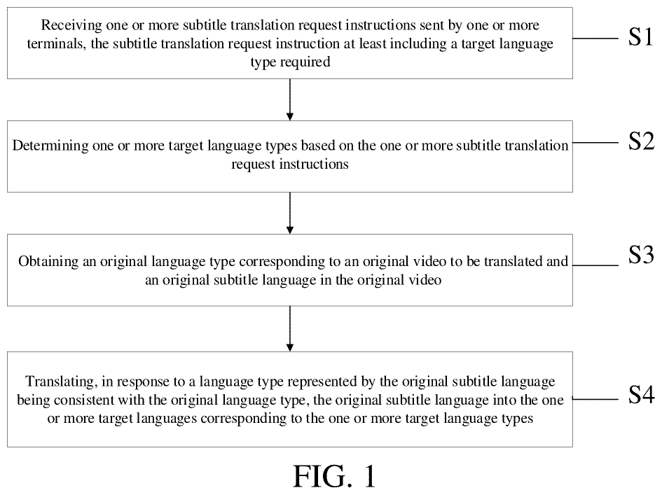

A subtitle processing method and a subtitle processing device according to an embodiment of the present disclosure will be described below with reference to FIG. 1 to FIG. 5.

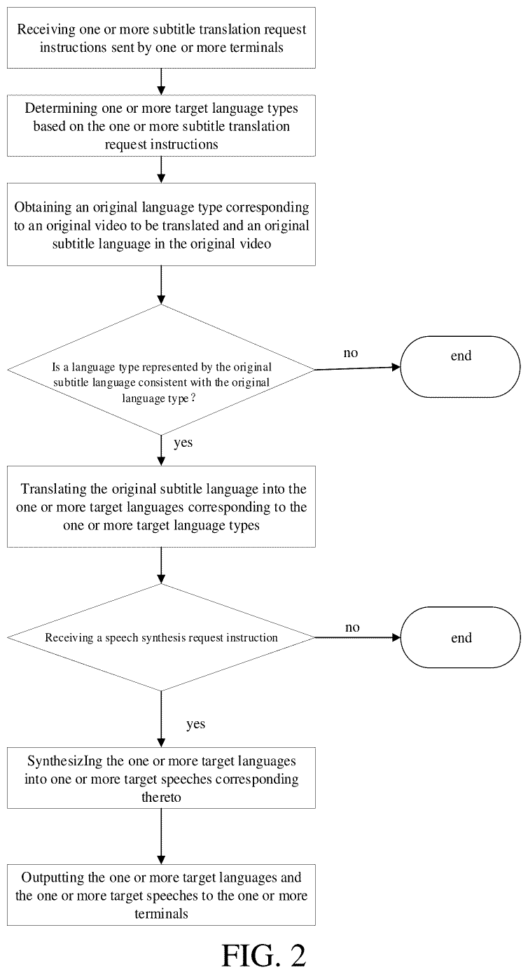

FIG. 1 is a schematic flow diagram of a subtitle processing method according to an embodiment of the present disclosure. FIG. 2 is a schematic flow diagram of a subtitle processing method according to another embodiment of the present disclosure. With reference to FIG. 1 and FIG. 2, the subtitle processing method includes following steps.

At step 1, one or more subtitle translation request instructions sent by one or more terminals are received. The subtitle translation request instruction at least includes a target language type required.

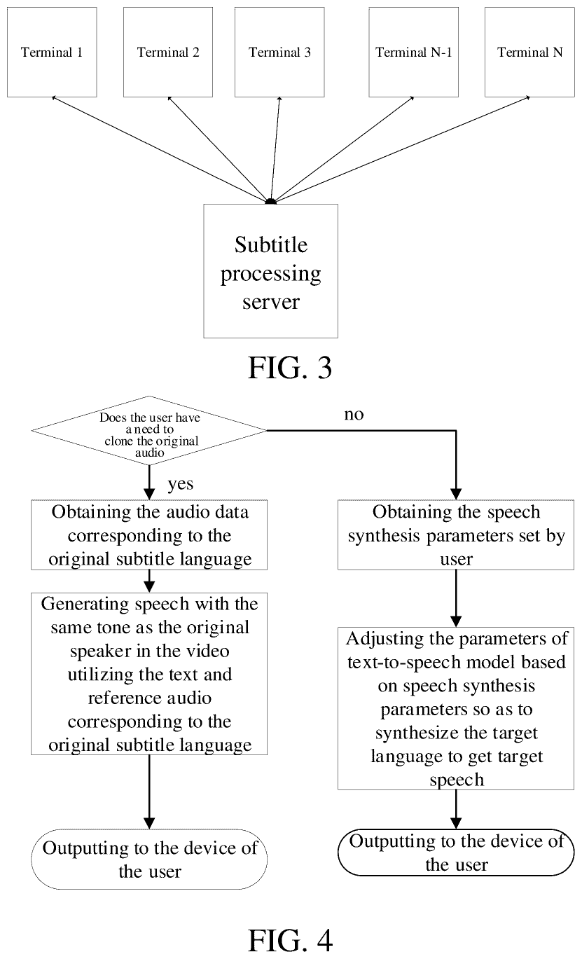

Specifically, during the process of video subtitle processing, as shown in FIG. 3, a subtitle processing server (i.e., a subtitle processing device) can receive subtitle translation request instructions sent by one or more terminals. The one or more terminals may be same devices or different devices, including but not limited to smartphones, tablets, smart TVs, etc. The subtitle translation request instruction at least includes a target language type required, in other words, a type of language or types of languages into which the user wants subtitles of an original video to be translated, for example, English, Chinese, French, Spanish, German, Japanese, etc.

At step 2, one or more target language types are determined based on the one or more subtitle translation request instructions.

Specifically, after receiving one or more subtitle translation request instructions, the one or more subtitle translation request instructions can be parsed, so as to extract an explicitly specified target language type from each subtitle translation request instruction, that is the one or more target language types corresponding to the one or more subtitle translation requests. For example, if a user requests to translate English subtitles into French, then the target language type in the request is French.

At step 3, an original language type corresponding to an original video to be translated and an original subtitle language in the original video are obtained.

Specifically, during the process of video subtitle processing, the original video to be translated can be parsed, including but not limited to parsing the file format, resolution, encoding method and audio data of the original video so as to obtain the original language type corresponding to the original video to be translated and the original subtitle language in the original video.

At step 4, in response to a language type represented by the original subtitle language being consistent with the original language type, the original subtitle language is translated into one or more target languages corresponding to the one or more target language types.

Specifically, during the process of video subtitle processing, language consistency check is performed. In other words, whether a language type represented by the original subtitle language is consistent with the original language type is verified so as to ensure the accuracy and effectiveness of translation work.

Furthermore, when the language type represented by the original subtitle language is consistent with the original language type, it means that the original subtitle language can accurately reflect the content of the original video. Therefore, appropriate translation engines or algorithms can be invoked to perform the translation task, including but not limited to employing neural machine translation models to translate the original subtitle language into one or more target languages corresponding to one or more target language types.

Therefore, through the subtitle processing method as described above, one or more target language types can be determined targetedly through reception of subtitle translation request instructions sent by one or more terminals, and thus the original subtitle language in the original video can be translated into one or more target languages so as to satisfy users' diverse language needs and to provide users with personalized and customized subtitle translation services, thereby enhancing user's viewing experience.

In an embodiment of the present disclosure, the obtaining the original subtitle language in the original video includes: obtaining a subtitle type of the original subtitle in the original video and obtaining the original subtitle language based on the subtitle type.

Specifically, since subtitle types may be different, the methods for obtaining the original subtitle language in the original video are different. Therefore, during obtaining the original subtitle language in the original video, the original subtitle type in the original video can be determined first, including but not limited to determining whether the original subtitles are embedded within the video or externally attached, or even determining whether subtitles are the present. Furthermore, based on different subtitle types, corresponding technical methods can be used to extract the original subtitle language from the original video.

In an embodiment of the present disclosure, the obtaining the original subtitle language based on the subtitle type includes:
obtaining, in response to the subtitle type indicating an embedded subtitle, text information of the embedded subtitle, and obtaining the original subtitle language based on the text information;
obtaining, in response to the subtitle type indicating an image-based subtitle, text information of the image-based subtitle through an optical character recognition technology, and obtaining the original subtitle language based on the text information; and
converting, in response to the subtitle type indicating a blank subtitle, audio data of the original video into text information through an automatic speech recognition technology, and obtaining the original subtitle language based on the text information.

Specifically, when acquiring the original subtitle language based on the subtitle type, if the subtitle type indicates an embedded subtitle, that is, the original subtitle text file has been edited and is a known text file (such as a subtitle file in SRT, ASS or other format, which consists of timecodes and subtitle text and typically includes a line of subtitle numbering, a line of timecode, and a line of subtitle data), and is provided together with the original video file. At this time, the text information of the embedded subtitles can be directly read, and the original subtitle language can be determined based on the text information, including but not limited to utilizing natural language processing technologies to analyze the text information to obtain the original subtitle language.

Furthermore, if the subtitle type indicates the image-based subtitle, that is, if the original video does not contain text subtitles but presents subtitles in the form of images, optical character recognition technology can be used to convert text in images into editable text. At the same time, corresponding timestamp is generated for each converted text segment to record the specific start and end time points of the subtitles, ensuring that the final subtitle text accurately matches the content of the original video to obtain the text information the image-based subtitle. Therefore, the original subtitle language can be obtained based on the text information, including but not limited to utilizing natural language processing technologies to analyze the text information to obtain the original subtitle language.

Furthermore, if the subtitle type indicates a blank subtitle, that is, if the original video does not contain any ready-made subtitles, an automatic speech recognition technology can be used to analyze the speech characteristics of the audio signals in the original video, so as to convert audio data of the original video into text information. The original subtitle language can be obtained based on the text information, including but not limited to utilizing natural language processing technology to analyze text information so as to obtain the original subtitle language.

In an embodiment of the present disclosure, the converting the audio data of the original video into the text information through the automatic speech recognition technology and obtaining the original subtitle language based on the text information further include: determining start time and end time of an audio based on an length of the audio data; determining a timestamp corresponding to the original subtitle language based on the start time and the end time; and obtaining the original subtitle language based on the text information and the timestamp.

Specifically, during converting the audio data of the original video into the text information through the automatic speech recognition technology, the start time and end time corresponding to each speech segment can be determined based on the length of the audio data. It means that for each converted text segment, its precise start time and end time in the original video can be recorded. For example, if a segment of dialogue starts at the 5th second of video playback and ends at the 10th second, then the textual record of this dialogue segment will also be marked with a time range from the 5th to the 10th second.

Furthermore, after determining the start time and end time of each audio segment, timestamps can be assigned to the corresponding text. The original subtitle language is obtained based on the text information and the timestamp so as to ensure that the generated original subtitle language can be precisely synchronized with the original video content. For example, if a certain sentence appears in the original video from the 30th second to the 35th second, the timestamp of the original subtitle language will also be set from the 30th second to the 35th second.

In an embodiment of the present disclosure, the translating the original subtitle language into the one or more target languages corresponding to the one or more target language types includes: translating the original subtitle language based on a Transformer architecture model so as to obtain the one or more target languages.

Specifically, when translating the original subtitle language into the one or more target languages corresponding to the one or more target language types, the Transformer architecture model can be used for translation of the original subtitle language. It can be understood that the Transformer architecture model is a neural network architecture based on a self-attention mechanism, and can deal with information on all input and output positions in parallel in terms of the natural language processing. That is, the original subtitle language can be translated into the one or more target languages corresponding to the one or more target language types so as to satisfy users' diverse language needs and to provide users with personalized and customized subtitle translation services. At the same time, a recursive or convolutional operation in traditional sequence-to-sequence model can be avoided, improving translation speed and accuracy. In addition, contextual information can be linked by using the Transformer architecture model so as to ensure that the original subtitle language after translated conforms to both the original meaning and the cultural background and expression habits of the target language.

In an embodiment of the present disclosure, with reference to FIG. 2 and FIG. 3, the subtitle processing method further includes: synthesizing, in response to receiving a speech synthesis request instruction, the one or more target languages into one or more target speeches corresponding thereto based on a text-to-speech model; and outputting the one or more target languages and the one or more target speeches to the one or more terminals.

Specifically, during the process of video subtitle processing, it can detect in real-time whether a speech synthesis request instruction is received. When the speech synthesis request instruction is received, the one or more target languages can be synthesized into one or more target speeches corresponding thereto based on the end-to-end text-to-speech model in deep learning. With reference to FIG. 4, it can be understood that, the text-to-speech model is a model capable of converting text to natural speech, including but not limited to Tacotron 2 model or FastSpeech model, and can generate coherent and highly natural speech from the target language, reducing the problem of mechanization in sound quality. At the same time, the text-to-speech model can perform, according to user's requirements, voice cloning on the original audio directly based on the original audio data. That is, the audio data corresponding to the original subtitle language can be obtained. Speech with the same timbre as the original speaker in the video is generated by using the text and reference audio corresponding to the original subtitle language.

Furthermore, with reference to FIG. 2 and FIG. 3, after the one or more target audios are generated, the one or more target languages and the one or more target audios can be outputted to multiple devices of users, including but not limited to smartphones, tablets, smart TVs, etc.

In an embodiment of the present disclosure, the synthesizing the one or more target languages into the one or more target speeches corresponding thereto based on the text-to-speech model further includes: obtaining a speech synthesis parameter set by a user; and performing speech synthesis on the one or more target languages based on the speech synthesis parameter to obtain the one or more target speeches.

Specifically, with reference to FIG. 4, during the process of generating the target audio, when a user has specific voice preferences (such as a particular timbre, speech rate, or even voice cloning to mimic a specific speaker's voice), it can obtain the user-configured speech synthesis parameters, including but not limited to adjusted timbre (e.g., male/female voice), speech rate (fast/slow adjustment), pitch (high/low variation), emotional expression (e.g., happy/sad), etc.

Furthermore, parameters of the text-to-speech model can be adjusted based on the speech synthesis parameters to perform speech synthesis on the target language, so as to obtain the target speech, thereby providing users with personalized voice experiences and meeting their individualized voice needs. For example, if a user desires a faster speech rate, the speed of speech generation in the text-to-speech model can increased. If the user desires a higher volume, the gain of the output audio in the text-to-speech model can be increased. For the user who desires to hear softer timbre, it can choose to lower the corresponding timbre parameter to generate speech that meets the user's requirements.

Above all, through the subtitle processing method according to embodiments of the present disclosure, one or more target language types can be determined targetedly through reception of subtitle translation request instructions sent by one or more terminals, and thus the original subtitle language in the original video can be translated into one or more target languages so as to satisfy users' diverse language needs and to provide users with personalized and customized subtitle translation services, thereby enhancing user's viewing experience. Furthermore, after a speech synthesis request instruction is received, the text-to-speech model can generate coherent and highly natural speech from the target language, reducing the problem of mechanization in sound quality. At the same time, parameters of the text-to-speech model can be adjusted based on the speech synthesis parameters to perform speech synthesis on the target language, thereby obtaining the target speech to provide users with personalized voice experiences and meeting their individualized voice needs.

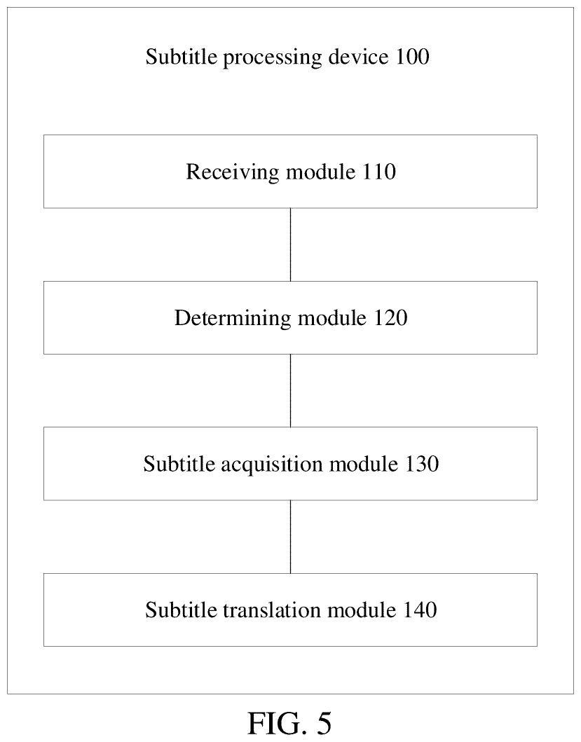

An embodiment of the present disclosure provides a subtitle processing device 100. As shown in FIG. 5, the subtitle processing device includes a receiving module 110, a determining module 120, a subtitle acquisition module 130 and a subtitle translation module 140. The receiving module 110 is configured to receive one or more subtitle translation request instructions sent by one or more terminals. The subtitle translation request instruction at least includes a target language type required.

The determining module 120 is configured to determine one or more target language types based on the one or more subtitle translation request instructions.

The subtitle acquisition module 130 is configured to obtain an original language type corresponding to an original video to be translated and an original subtitle language in the original video.

The subtitle translation module 140 is configured to translate, when a language type represented by the original subtitle language is consistent with the original language type, the original subtitle language into the one or more target languages corresponding to the one or more target language types.

In some embodiments, when obtaining the original subtitle language in the original video, the subtitle acquisition module 130 is specifically configured to obtain a subtitle type of the original subtitle in the original video and obtain the original subtitle language based on the subtitle type.

In some embodiments, when obtaining the original subtitle language based on the subtitle type, the subtitle acquisition module 130 is specifically configured to: obtain, in response to the subtitle type indicating an embedded subtitle, text information of the embedded subtitle, and obtain the original subtitle language based on the text information; obtain, in response to the subtitle type indicating an image-based subtitle, text information of the image-based subtitle through an optical character recognition technology, and obtain the original subtitle language based on the text information; and convert, in response to the subtitle type indicating a blank subtitle, audio data of the original video into text information through an automatic speech recognition technology, and obtain the original subtitle language based on the text information.

In some embodiments, when converting the audio data of the original video into the text information through the automatic speech recognition technology and obtaining the original subtitle language based on the text information, the subtitle acquisition module 130 is further configured to determine start time and end time of an audio based on an length of the audio data, determine a timestamp corresponding to the original subtitle language based on the start time and the end time, and obtain the original subtitle language based on the text information and the timestamp.

In some embodiments, when translating the original subtitle language into the one or more target languages corresponding to the one or more target language types, the subtitle translation module 140 is specifically configured to translate the original subtitle language based on a Transformer architecture model so as to obtain the one or more target languages.

In some embodiments, the subtitle processing device 100 is further configured to: synthesize, in response to receiving a speech synthesis request instruction, the one or more target languages into one or more target speeches corresponding thereto based on a text-to-speech model; and output the one or more target languages and the one or more target speeches to the one or more terminals.

In some embodiments, when synthesizing the one or more target languages into the one or more target speeches corresponding thereto based on the text-to-speech model, the subtitle processing device 100 is further configured to obtain a speech synthesis parameter set by a user and perform speech synthesis on the one or more target languages based on the speech synthesis parameter to obtain the one or more target speeches.

With the subtitle processing device 100 in the present disclosure, one or more target language types can be determined targetedly through reception of subtitle translation request instructions sent by one or more terminals, and thus the original subtitle language in the original video can be translated into one or more target languages so as to satisfy users' diverse language needs and to provide users with personalized and customized subtitle translation services, thereby enhancing user's viewing experience. Furthermore, after a speech synthesis request instruction is received, the text-to-speech model can generate coherent and highly natural speech from the target language, reducing the problem of mechanization in sound quality. At the same time, parameters of the text-to-speech model can be adjusted based on the speech synthesis parameters to perform speech synthesis on the target language, thereby obtaining the target speech to provide users with personalized voice experiences and meeting their individualized voice needs.

To achieve the above aims, an embodiment in a third embodiment of the present disclosure provides an electronic device. The electronic device includes: the subtitle processing device according to any of the embodiments in the second aspect of the present disclosure. Alternatively, the electronic device includes a processor, a memory and a subtitle processing program that is stored in the memory and that is executable in the processor. The subtitle processing program when executed by the processor, implements the subtitle processing method according to any of the embodiments of the first aspect of the present disclosure.

With the electronic device according to embodiments of the present disclosure, one or more target language types can be determined targetedly through reception of subtitle translation request instructions sent by one or more terminals, and thus the original subtitle language in the original video can be translated into one or more target languages so as to satisfy users' diverse language needs and to provide users with personalized and customized subtitle translation services, thereby enhancing user's viewing experience. Furthermore, after a speech synthesis request instruction is received, the text-to-speech model can generate coherent and highly natural speech from the target language, reducing the problem of mechanization in sound quality. At the same time, parameters of the text-to-speech model can be adjusted based on the speech synthesis parameters to perform speech synthesis on the target language, thereby obtaining the target speech to provide users with personalized voice experiences and meeting their individualized voice needs.

To achieve the above aims, an embodiment in the fourth aspect of the present disclosure provides a non-transitory computer readable storage medium. A subtitle processing program is stored on the non-transitory computer readable storage medium. The subtitle processing program when executed by a processor, implements the subtitle processing method according to any of the embodiments in the first aspect of the present disclosure.

With the non-transitory computer readable storage medium according to embodiments of the present disclosure, when the subtitle processing program stored on the non-transitory computer readable storage medium is executed by a processor, one or more target language types can be determined targetedly through reception of subtitle translation request instructions sent by one or more terminals, and thus the original subtitle language in the original video can be translated into one or more target languages so as to satisfy users' diverse language needs and to provide users with personalized and customized subtitle translation services, thereby enhancing user's viewing experience. Furthermore, after a speech synthesis request instruction is received, the text-to-speech model can generate coherent and highly natural speech from the target language, reducing the problem of mechanization in sound quality. At the same time, parameters of the text-to-speech model can be adjusted based on the speech synthesis parameters to perform speech synthesis on the target language, thereby obtaining the target speech to provide users with personalized voice experiences and meeting their individualized voice needs.

In the description of the specification, description with reference to the terms “one embodiment”, “some embodiments”, “illustrative embodiments”, “examples”, “specific examples”, or “some examples” means that the specific features, structures, materials, or characteristics described in conjunction with the embodiments or examples are included in at least one embodiment or example of the present disclosure. In this specification, the illustrative expressions of the above terms may not necessarily refer to the same embodiment or example.

Although the embodiments of the present disclosure have been shown and described, those skilled in the art can understand that various changes, modifications, substitutions, and variations can be made to these embodiments without departing from the principles and purposes of the present disclosure. The scope of the present disclosure is limited by the claims and their equivalents.

What is claimed is:

1. A subtitle processing method, comprising:
receiving one or more subtitle translation request instructions sent by one or more terminals, the subtitle translation request instruction at least comprising a target language type required;
determining one or more target language types based on the one or more subtitle translation request instructions;
obtaining an original language type corresponding to an original video to be translated and an original subtitle language in the original video; and
translating, in response to a language type represented by the original subtitle language being consistent with the original language type, the original subtitle language into one or more target languages corresponding to the one or more target language types.

2. The subtitle processing method according to claim 1, wherein said obtaining the original subtitle language in the original video comprises:
obtaining a subtitle type of an original subtitle in the original video; and
obtaining the original subtitle language based on the subtitle type.

3. The subtitle processing method according to claim 2, wherein said obtaining the original subtitle language based on the subtitle type comprises:
obtaining, in response to the subtitle type indicating an embedded subtitle, text information of the embedded subtitle, and obtaining the original subtitle language based on the text information;
obtaining, in response to the subtitle type indicating an image-based subtitle, text information of the image-based subtitle through an optical character recognition technology, and obtaining the original subtitle language based on the text information; and
converting, in response to the subtitle type indicating a blank subtitle, audio data of the original video into text information through an automatic speech recognition technology, and obtaining the original subtitle language based on the text information.

4. The subtitle processing method according to claim 3, wherein said converting the audio data of the original video into the text information through the automatic speech recognition technology and obtaining the original subtitle language based on the text information, further comprise:
determining start time and end time of an audio based on an length of the audio data;
determining a timestamp corresponding to the original subtitle language based on the start time and the end time; and
obtaining the original subtitle language based on the text information and the timestamp.

5. The subtitle processing method according to claim 1, wherein said translating the original subtitle language into the one or more target languages corresponding to the one or more target language types comprises:
translating the original subtitle language based on a Transformer architecture model so as to obtain the one or more target languages.

6. The subtitle processing method according to claim 1, further comprising:
synthesizing, in response to receiving a speech synthesis request instruction, the one or more target languages into one or more target speeches corresponding thereto based on a text-to-speech model; and
outputting the one or more target languages and the one or more target speeches to the one or more terminals.

7. The subtitle processing method according to claim 1, wherein said synthesizing the one or more target languages into the one or more target speeches corresponding thereto based on the text-to-speech model further comprises:
obtaining a speech synthesis parameter set by a user; and
performing speech synthesis on the one or more target languages based on the speech synthesis parameter to obtain the one or more target speeches.

8. An electronic device, comprising:
a processor, a memory and a subtitle processing program that is stored in the memory and that is executable in the processor, the subtitle processing program when executed by the processor, implements operations of:
receiving one or more subtitle translation request instructions sent by one or more terminals, the subtitle translation request instruction at least comprising a target language type required;
determining one or more target language types based on the one or more subtitle translation request instructions;
obtaining an original language type corresponding to an original video to be translated and an original subtitle language in the original video; and
translating, in response to a language type represented by the original subtitle language being consistent with the original language type, the original subtitle language into one or more target languages corresponding to the one or more target language types.

9. The electronic device according to claim 8, wherein said obtaining the original subtitle language in the original video comprises:
obtaining a subtitle type of an original subtitle in the original video; and
obtaining the original subtitle language based on the subtitle type.

10. The electronic device according to claim 9, wherein said obtaining the original subtitle language based on the subtitle type comprises:
obtaining, in response to the subtitle type indicating an embedded subtitle, text information of the embedded subtitle, and obtaining the original subtitle language based on the text information;
obtaining, in response to the subtitle type indicating an image-based subtitle, text information of the image-based subtitle through an optical character recognition technology, and obtaining the original subtitle language based on the text information;
and converting, in response to the subtitle type indicating a blank subtitle, audio data of the original video into text information through an automatic speech recognition technology, and obtaining the original subtitle language based on the text information.

11. The electronic device according to claim 10, wherein said converting the audio data of the original video into the text information through the automatic speech recognition technology and obtaining the original subtitle language based on the text information, further comprise:
determining start time and end time of an audio based on a length of the audio data;
determining a timestamp corresponding to the original subtitle language based on the start time and the end time; and
obtaining the original subtitle language based on the text information and the timestamp.

12. The electronic device according to claim 8, wherein said translating the original subtitle language into the one or more target languages corresponding to the one or more target language types comprises:
translating the original subtitle language based on a Transformer architecture model so as to obtain the one or more target languages.

13. The electronic device according to claim 8, wherein the subtitle processing program when executed by the processor, further implements operations of:
synthesizing, in response to receiving a speech synthesis request instruction, the one or more target languages into one or more target speeches corresponding thereto based on a text-to-speech model; and
outputting the one or more target languages and the one or more target speeches to the one or more terminals.

14. The electronic device according to claim 8, wherein said synthesizing the one or more target languages into the one or more target speeches corresponding thereto based on the text-to-speech model further comprises:
obtaining a speech synthesis parameter set by a user; and
performing speech synthesis on the one or more target languages based on the speech synthesis parameter to obtain the one or more target speeches.

15. A non-transitory computer readable storage medium, on which a subtitle processing program is stored, wherein the subtitle processing program when executed by a processor, implements operations of:
receiving one or more subtitle translation request instructions sent by one or more terminals, the subtitle translation request instruction at least comprising a target language type required;
determining one or more target language types based on the one or more subtitle translation request instructions;
obtaining an original language type corresponding to an original video to be translated and an original subtitle language in the original video; and
translating, in response to a language type represented by the original subtitle language being consistent with the original language type, the original subtitle language into one or more target languages corresponding to the one or more target language types.

16. The non-transitory computer readable storage medium according to claim 15, wherein said obtaining the original subtitle language in the original video comprises:
obtaining a subtitle type of an original subtitle in the original video; and
obtaining the original subtitle language based on the subtitle type.

17. The non-transitory computer readable storage medium according to claim 16, wherein said obtaining the original subtitle language based on the subtitle type comprises:
obtaining, in response to the subtitle type indicating an embedded subtitle, text information of the embedded subtitle, and obtaining the original subtitle language based on the text information;
obtaining, in response to the subtitle type indicating an image-based subtitle, text information of the image-based subtitle through an optical character recognition technology, and obtaining the original subtitle language based on the text information; and
converting, in response to the subtitle type indicating a blank subtitle, audio data of the original video into text information through an automatic speech recognition technology, and obtaining the original subtitle language based on the text information.

18. The non-transitory computer readable storage medium according to claim 17, wherein said converting the audio data of the original video into the text information through the automatic speech recognition technology and obtaining the original subtitle language based on the text information, further comprise:
determining start time and end time of an audio based on a length of the audio data;
determining a timestamp corresponding to the original subtitle language based on the start time and the end time; and
obtaining the original subtitle language based on the text information and the timestamp.

19. The non-transitory computer readable storage medium according to claim 15, wherein said translating the original subtitle language into the one or more target languages corresponding to the one or more target language types comprises:
translating the original subtitle language based on a Transformer architecture model so as to obtain the one or more target languages.

20. The non-transitory computer readable storage medium according to claim 15, wherein the subtitle processing program when executed by a processor, further implements operations of:
synthesizing, in response to receiving a speech synthesis request instruction, the one or more target languages into one or more target speeches corresponding thereto based on a text-to-speech model; and
outputting the one or more target languages and the one or more target speeches to the one or more terminals.
